(19) United States
(12) Patent Application Publication
(10) Pub. No.: US 2014/0279566 A1
(43) Pub. Date: Sep. 18, 2014

(54) SECURE MOBILE PAYMENT USING MEDIA BINDING

(71) Applicant: Samsung Electronics Co., Ltd., Suwon (KR)

(72) Inventors: Sanjeev Verma, San Jose, CA (US); Glen D. Stone, Los Gatos, CA (US)

(73) Assignee: Samsung Electronics Co., Ltd., Suwon (KR)

(21) Appl. No.: 14/015,611

(22) Filed: Aug. 30, 2013

Related U.S. Application Data
(60) Provisional application No. 61/789,457, filed on Mar. 15, 2013.

(51) Int. Cl. G06Q 20/38; G06Q 20/32

(52) U.S. Cl. CPC G06Q 20/38215; G06Q 20/322
USPC 705/76

(57) ABSTRACT

A method for mobile payment includes generating, by a financial institution, a unique credential based on user access information and media binding information that is cryptographically bound to media using a unique media identification. The financial institution stores the credential and media binding information in the form of authentication code in a memory used by an electronic device. The stored credential and media binding information is accessed using the user access information for a payment transaction. A digital certificate is generated using the credential and media binding information. The digital certificate is presented to the financial institution for the payment transaction. The memory is authenticated and binding of the credential to the memory is verified prior to completing the payment transaction.

### CROSS-REFERENCE TO RELATED APPLICATIONS

This application claims the priority benefit of U.S. Provisional Patent Application Ser. No. 61/789,457, filed Mar. 15, 2013, incorporated herein by reference in its entirety.

### TECHNICAL FIELD

One or more embodiments relate generally to mobile payment and, in particular, to secure mobile payment using media binding.

### BACKGROUND

Credit card payment typically uses a four party payment system including the bank customer/cardholder that desires to obtain goods or services, a merchant or retailer that uses a point-of-service (POS) card reader and provides goods or services, the issuer (e.g., bank) that provides the customer with a means to pay for the goods or services (e.g., through billing, online payment options, etc.), and the Acquirer with whom the merchant interacts to receive funds for the goods or services.

### SUMMARY

In one embodiment, a method provides mobile payment. One embodiment comprises a method that includes generating, by a financial institution, a unique credential based on user access information and media binding information that is cryptographically bound to media using a unique media identification. In one embodiment, the financial institution stores the credential and media binding information in the form of authentication code in a memory used by an electronic device. In one embodiment, the stored credential and media binding information is accessed using the user access information for a payment transaction. In one embodiment, a digital certificate is generated using the credential and media binding information. In one embodiment, the digital certificate is presented to the financial institution for the payment transaction. In one embodiment, the memory is authenticated and binding of the credential to the memory is verified prior to completing the payment transaction.

One embodiment provides a system for mobile payment. In one embodiment a server generates a unique credential based on user access information and media binding information that is cryptographically bound to media using a unique media identification, and stores the credential and media binding information in the form of authentication code in a memory used by an electronic device through a secure channel. In one embodiment, an electronic device accesses the stored credential and media binding information from the memory using the user access information for a payment transaction, and generates a digital certificate using the credential. In one embodiment, a near field communication (NFC) interface passes the digital certificate to the server for the payment transaction. In one embodiment, the server authenticates the memory and verifies binding of the credential to the memory prior to completing the payment transaction.

Another embodiment provides a server for mobile payment that comprises a credential service that uses a processor to generate a unique credential based on user access information and media binding information that is cryptographically bound to media using a unique media identification, and stores the credential and media binding information in a memory used by an electronic device through a secure channel. In one embodiment an authorization service authenticates the memory and verifies the binding of the credential to the memory prior to completing a requested payment transaction based on a digital certificate generated by the electronic device using the credential and media binding information.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system for mobile payment using an electronic device, according to an embodiment.

FIG. 3 shows an architecture for storage and access control for mobile payment using an electronic device, according to an embodiment.

FIG. 4 shows a memory binding authentication flow, according to an embodiment.

FIG. 5 shows an example flow for a mobile transaction with a cloud computing environment for mobile payment using an electronic device, according to an embodiment.

FIG. 6 shows a flow diagram for mobile payment using an electronic device, according to an embodiment.

FIG. 7 shows an architecture implementation for mobile payment using an electronic device, according to an embodiment.

FIG. 8 shows a block diagram of a flow chart for mobile payment using an electronic device, according to an embodiment.

FIG. 9 is a high-level block diagram showing an information processing system comprising a computing system implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to payment for point-of-service (POS) purchases using an electronic device. One embodiment provides secured purchasing using authentication of a memory device and secure credential. In one embodiment, the electronic device comprises a mobile electronic device capable of data communication over a communication link, such as a wireless communication link. Examples of such mobile device include a mobile phone device, a mobile tablet device, a wearable device, portable computing device, etc.

In one embodiment, a method provides mobile payment using an electronic device. One embodiment comprises a method that includes generating, by a financial institution, a unique credential based on user access information and media binding information that is cryptographically bound to media using a unique media identification. In one embodiment, the financial institution stores the credential and media binding information in a memory used by an electronic device. In one embodiment, the stored credential and media binding information is accessed using the user access information for a payment transaction. In one embodiment, a digital certificate is generated using the credential and media binding information. In one embodiment, the digital certificate is presented to the financial institution for the payment transaction. In one embodiment, the memory is authenticated and binding of the credential to the memory is verified prior to completing the payment transaction.

One or more embodiments address the security in a mobile payment ecosystem by using enhanced media identification (EMID) technology and a private cloud computing environment managed and authenticated by financial institutions (e.g., credit card issuers). In one embodiment, a security issue arising out of a theft of a mobile device is handled by revoking a credential of a memory device by financial institutions. One embodiment provides for replacement of plastic credit cards by digital credit cards, such as digital certificates generated by electronic devices.

In one embodiment, the installation and management of a mobile payment credential in the mobile electronic device takes place directly between the private computing environment (e.g., of financial institutions, a cloud computing environment, etc.) and the electronic device without any involvement of other entities, such as a mobile network operator (MNO).

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols may include, for example, GSM, GSM plus EDGE, CDMA, quadband, and other cellular protocols. In another example, a long range communications protocol may include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a cellular telephone or a landline telephone, a personal e-mail or messaging device with audio and/or video capabilities, pocket-sized personal computers such as an iPAQ Pocket PC, available by Hewlett Packard Inc., of Palo Alto, Calif., personal digital assistants (PDAs), wearable devices, a desktop computer, a laptop computer, tablet computers, pad-type computing devices, a media player, and any other device capable of communicating wirelessly (with or without the aid of a wireless-enabling accessory system) or via wired pathways (e.g., using traditional telephone wires). The communications operations may include any suitable form of communication, including for example, voice communication (e.g., telephone calls), data communication (e.g., e-mails, text messages, media messages), near field communication (NFC), or combinations of these (e.g., video conferences).

FIG. 2 shows a functional block diagram of an architecture system 100 that may be used for mobile payment using an electronic device 120, according to an embodiment. Both transmitting device 12 and receiving device 11 may include some or all of the features of electronics device 120. In one embodiment, the electronic device 120 may comprise a display 121, a microphone 122, an audio output 123, an input mechanism 124, communications circuitry 125, control circuitry 126, a camera 127, a global positioning system (GPS) receiver module 128, an NFC interface 129, a secure memory module 140, and any other suitable components. In one embodiment, a mobile payment application 130 (e.g., an e-wallet application) executes on the electronic device 120. In one embodiment, an e-wallet table or list may store information associated with multiple credit cards. In one embodiment, the electronic device 120 may communicate with the private computing environment 160 (e.g., a cloud computing environment, local or remote server, etc.) that comprises financial entities (e.g., banks, credit card issuers, etc.) that process credit cards and use thereof. In one embodiment, the NFC interface 129 communicates with the NFC device 150 that may be coupled with or part of a POS system that accepts credit card payments for a merchant.

In one embodiment, the secure memory module 140 may comprise a removable memory device or card, or may comprise a memory device embedded in the electronic device 120. In one embodiment, the memory module 140 comprises memory that is secure and separate from other memory available for the electronic device 120.

In one embodiment, all of the applications employed by an audio output 123, a display 121, an input mechanism 124, communications circuitry 125 and a microphone 122 may be interconnected and managed by control circuitry 126. In one embodiment, the audio output 123 may include any suitable audio component for providing audio to the user of the electronics device 120. For example, the audio output 123 may include one or more speakers (e.g., mono or stereo speakers) built into the electronics device 120. In some embodiments, the audio output 123 may include an audio component that is remotely coupled to electronics device 120. For example, the audio output 123 may include a headset, headphones or earbuds that may be coupled to communications device with a wire (e.g., coupled to the electronics device 120 with a jack) or wirelessly (e.g., Bluetooth® headphones or a Bluetooth® headset).

In one embodiment, the display 121 may include any suitable screen or projection system for providing a display visible to the user. For example, the display 121 may include a screen (e.g., an LCD screen) that is incorporated in electronics device 120. As another example, the display 121 may include a movable display or a projecting system for providing a display of content on a surface remote from the electronics device 120 (e.g., a video projector). The display 121 may be operative to display content (e.g., information regarding communications operations or information regarding available media selections) under the direction of control circuitry 126.

In one embodiment, the input mechanism 124 may be any suitable mechanism or user interface for providing user inputs or instructions to the electronics device 120. The input mechanism 124 may take a variety of forms, such as a button, keypad, dial, a click wheel, or a touch screen. The input mechanism 124 may include a multi-touch screen. The input mechanism 124 may include a user interface that may emulate a rotary phone or a multi-button keypad, which may be implemented on a touch screen or the combination of a click wheel or other user input device and a screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, flash memory, ROM, and/or RAM. In some embodiments, the memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an ASR application, a dialog application, a map application, a media application (e.g., QuickTime®, MobileMusic.app, or MobileVideo.app). In some embodiments, the electronics device 120 may include one or several applications operative to perform communications operations. For example, the electronics device 120 may include a messaging application, a mail application, a telephone application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include the microphone 122 to allow the user to transmit audio (e.g., voice audio) during a communications operation or as a means of establishing a communications operation or as an alternate to using a physical user interface. The microphone 122 may be incorporated in electronics device 120, or may be remotely coupled to the electronics device 120. For example, the microphone 122 may be incorporated in wired headphones, or the microphone 122 may be incorporated in a wireless headset.

In one embodiment, the electronics device 120 may include any other component suitable for performing a communications operation. For example, the electronics device 120 may include a power supply, ports, or interfaces for coupling to a host device, a secondary input mechanism (e.g., an ON/OFF switch), or any other suitable component.

In one embodiment, a user may direct the electronics device 120 to perform a communications operation using any suitable approach. As one example, a user may receive a communications request from another device (e.g., an incoming telephone call, an email or text message, an instant message) and may initiate a communications operation by accepting the communications request. As another example, the user may initiate a communications operation by identifying another communications device and transmitting a request to initiate a communications operation (e.g., dialing a telephone number, sending an email, typing a text message, or selecting a chat screen name and sending a chat request).

In one embodiment, the electronic device 120 may comprise a mobile device that may utilize mobile device hardware functionality including: the display 121, the GPS receiver module 128, the camera 127, a compass module, and an accelerometer and gyroscope module. The GPS receiver module 128 may be used to identify a current location of the mobile device (i.e., user). The compass module is used to identify direction of the mobile device. The accelerometer and gyroscope module is used to identify tilt of the mobile device. In other embodiments, the electronic device may comprise a television or television component system.

FIG. 3 shows an architecture 300 for storage and access control for mobile payment using an electronic device 120, according to an embodiment. In one embodiment, an EMID issuer 310 provides the remote host 305 (e.g., a financial institution application running on a server in the computing environment 160) with information including a secure location on a memory device of the secure memory module 140 that contains a secret or code.

In one embodiment, EMID technology is used to provide secure mobile finance services on the electronic device 120. EMID technology enables a unique way of identifying flash memory by embedding a unique secret (e.g., code) in the secure area (e.g., in the secure memory module 140) of memory (e.g., flash memory) at the time of manufacturing the memory device. In one embodiment, the unique secret never leaves the flash memory. In one embodiment, the remote host 305 transmits and stores a user credential authorization key 315 in the memory module 140. In one embodiment, an authorized host device (e.g., the remote host 305) may access the secret value to generate a unique identification (ID) for a certain application (e.g., application 130). The EMID is not stored anywhere in the memory device. In one embodiment, the access to the unique secret is provided through a family key. The family key is derived by using one key from a set of device key sets that every host device is provided with by an EMID issuer 310. The family key is decrypted by reading a family key block area of the memory in the memory module 140 (e.g., a flash memory device). The memory manufacturer may revoke a host device by updating the family key block so that a revoked Host is not able to derive a family key needed to decrypt the unique secret.

In one embodiment, a user credential (determined by the remote host 305, e.g., a financial institution) binds to the memory device of the memory module 140 so that the credential may be revoked by the remote host 305 (e.g., a financial institution) application if the device is lost or stolen. In one embodiment, direct remote credential management is allowed on the secure memory module 140 by the remote host 305 without the direct involvement of the end user of the electronic device 120. This provides a flexible solution where the credential (or secure element) may be easily moved around between the computing environment 160 and the secure memory module 140.

In one embodiment, the remote host 305 also stores an expiry time element 330 in order to limit the access of the credential that may be accessed and decrypted by the electronic device 120. In one embodiment, the expiry time element 330 includes a time limitation (e.g., a time stamp, code, etc.) that must be periodically updated by the remote host 305. In one embodiment, the remote host 305 also stores a media ID message authentication code (MAC) on the electronic device 120 to bind the UserID to the media of the secure memory module 140. In one embodiment, the remote host 305 first authenticates the binding of the credential of the memory device of the secure memory module 140 before accepting the credential from the end user. In one embodiment, the media ID MAC 340 is generated as follows: Media ID MAC=CMAC (EMID, Credentials), where CMAC represents a cipher-based MAC.

In one embodiment, a user of the electronic device 120 first establishes an account at the financial institution (e.g., remote host 305) by using user access information (e.g., a username and a password). In one embodiment, the financial institution then generates an authorization key (auth_key) using the user access information (e.g., user name and password) as input to a function, such as a hash function-auth_key=PRF (username, password).

In one embodiment, the remote host 305 stores the encrypted credential (encrypted using auth_key) at its assigned protected area in the memory device of the secure memory module 140. In one embodiment, the credential is generated by cryptographically binding the UserID to the media (through EMID). In one embodiment, the credential may be read by the electronic device 120 over a secure channel. In one embodiment, the electronic device 120 (Host device) uses the auth_key 315 to decrypt the credentials stored at the protected area in the secure memory module 140. In one embodiment, the auth_key is generated locally by first prompting a user to enter their username and password via the electronic device 120. In this embodiment, the credential may be decrypted correctly only by the rightful owner of the credential. The credential is then presented to the remote host 305 (e.g., the financial institution) through a merchant in the form of a user digital (e.g., credit card) certificate. The remote host (e.g., financial institution) then makes sure that the credential is bound to the secure memory module 140 and originating from the authorized user before completing the transaction.

In one embodiment, the remote host 305 (e.g., a financial institution such as a Bank, credit card companies, etc.) installs and binds encrypted user credential (encrypted by the auth_key 315) for the corresponding application (financial institution) on its assigned protected memory area (removable or embedded) of the secure memory module 140 over a secure channel. In one embodiment, the remote host 305 may both read and write the credential on the secure memory module 140. In one embodiment, the access control information is provided in the Host certificate issued by the EMID issuer 310.

In one embodiment, the local Host is the electronic device 120, and may (Mobile Device) read the encrypted stored credential over the secure channel when desired to use the credential at the time of a financial transaction. In one embodiment, the electronic device 120 decrypts the credential using the auth_key 315 by prompting a user to enter a username and password. In one embodiment, the electronic device 120 cannot modify the credential stored in the secure area of the secure memory module 140.

In one embodiment, the user credential is cryptographically bound by the remote host 305 (e.g., financial institution) to the media of the secure memory module 140, and the credential is generated as: User credential=PRF (UserID, EMID); where PRF indicated pseudo-random function, such as advanced encryption standard (AES) and UserID is the user identity of the end user at the remote host 305 (e.g., at the financial institution). In one embodiment, the expiry time 330 is stored along with the credential, and the credential is valid only for a certain time period as determined by the remote host 305 (e.g., financial institution) issuing the credential.

FIG. 4 shows a memory binding authentication flow 400, according to an embodiment. In one embodiment, the remote host 305 first authenticates the binding of the credential of the memory device of the secure memory module 140 before accepting the credential from the end user. This ensures that the source of the credential is a valid device containing the authenticated memory (embedded or removable). In one embodiment, the credential is generated at 410 using a PRF, such as AES. In one embodiment, the media ID MAC is generated at 420 (e.g., CMAC (EMID, Credentials).

In one embodiment, when the end user wants to initiate a financial transaction, the local Host device (electronic device 120) creates a digital certificate (e.g., a User Credit Card certificate) by reading the User credential and Media ID MAC from the memory device of the secure memory module 140 and signs it using its private key at 340. If the user credential is expired then it asks the remote host 305 (e.g., financial institution) to create a new user credential and store it in the memory device of the secure memory module 140. In one embodiment, if the media ID MAC that is read from the secure memory module 140 does not match the known media ID MAC known by the remote host 305, the payment transaction process is aborted. Otherwise, in one embodiment, the UserID is found to be bound to the secure media at 430 and the transaction is processed at 440.

FIG. 5 shows an example flow 600 for a mobile transaction with a cloud computing environment for mobile payment using an electronic device 120, according to an embodiment. In one embodiment, the flow 600 starts with a request for a new account from the electronic device 120 to the remote host 305. In one embodiment, a user first requests a credit card at the website of a financial institution (e.g., the remote host 305) by presenting his/her user name and password along with other information. In one embodiment, the financial institution then generates a unique UserID by performing a selected cryptographic operation (e.g., a PRF, such as AES) on the user access information. In one embodiment, the secure memory module 140 includes a memory controller 620 and a memory device 630 including an EMID decoder.

In one embodiment, the remote host 305 establishes a secure channel to the memory device of the secure memory module 140 through the electronic device 120 and installs the encrypted credential in the assigned protected area of the memory device of the secure memory module 140, along with the expiry time 330 (FIG. 3) of the credential. In one embodiment, the remote host 305 also generates the memory ID MAC 340 and stores it in the memory device of the secure memory module 140. It should be noted that the request for a new account and the generation and storing of the credential and memory ID MAC are needed only when either the user first establishes an account with the financial institution or when the User credential expires.

In one embodiment, an end user using the electronic device 120 goes to a POS (Point Of Sale) device (e.g., NFC device 610) and selects a credit card from his eWallet application (e.g., application 130, FIG. 2). In one embodiment, the user is prompted on the display 121 to enter his/her username and password. In one embodiment, the electronic device 120 reads and decrypts the stored credentials in the protected area of the secure memory module 140. In one embodiment, the electronic device 120 generates a digital certificate (e.g., a user credit card certificate) by using the credential and then presents it to a merchant over the NFC interface 129.

In one embodiment, a merchant uses the financial institution network to present the user digital certificate (e.g., credit card certificate) to the financial institution. In one embodiment, the remote host application of the remote host 305 (e.g., the financial institution) first authenticates the memory device of the secure memory module 140 and then authenticates the credential in order to authorize the user. In one embodiment, the remote host 305 (i.e., the financial institution) completes the requested transaction after performing the authorizations in order to determine that the request is issued from an authorized user using a certified device.

In one embodiment, the hosting of the application 130 and the stored encrypted credentials are provided by the remote hosts for one or more credit cards, where credit card issuers (e.g., financial institutions) provide the processing for their respective credentials. In one embodiment, the computing environment 160 is private and only hosted by a numbers of banks and financial institutions.

FIG. 6 shows a flow diagram 700 for mobile payment using an electronic device 120, according to an embodiment. In one embodiment, the flow diagram 700 includes the flow interactions for the secure memory module 140, the electronic device 120, the user, the NFC device 610 (e.g., POS device), credit or bank card 701, remote host 305 and the application 130 executing on the electronic device 130. In one embodiment, at flow 705 the user uses the electronic device 120 to request for a credential from a particular credit card entity 701 at the remote host 305. At flow 710, the remote host 305 uses a secure channel over a network in order to access the secure storage module 140 for assignment of the secure storage area of the secure memory module 140.

In one embodiment, in flow 715 the remote host 305 installs the credential, media ID MAC 340 and expiry time element 330 in the secure memory module 140. In one embodiment, in flow 720, upon a user requesting a financial transaction using the application 130, the user is locally authenticated based on the user access information (e.g., username and password) and EMID technology authentication of the media of the secure memory module 140 (flow 725). In flow 730, the credential is read from the secure memory module 140 by the electronic device 120 using the application 130, and NFC authentication occurs in flow 735.

In one embodiment, in flow 740, mutual authentication by the remote host 305 occurs. In flow 745, the digital certificate generated (e.g., credit card certificate) and a purchase token are forwarded to the remote host 305. In one embodiment, upon processing by the remote host 305, in flow 750 the purchase is approved to proceed.

FIG. 7 shows an architecture implementation 800 for mobile payment using an electronic device 120, according to an embodiment. In one embodiment, the implementation 800 includes a remote host 305 that may be anyone of multiple credit card financial institutions, banks, etc, an EMID issuer 810 and the electronic device 120 including the secure memory module 140 (either removable or embedded). In one embodiment, the electronic device 120 executes the application 130 that communicates with a trusted execution environment (TEE) API 850 and trusted operating system (OS) 860 implementation.

In one embodiment, the EMID issuer 810 forwards the application specific secret value (ASSV) 820 to the mobile financial application that interacts in the cloud 840 with the secure elements 830 managed (i.e., created, revoked) by the EMID issuer. In one embodiment, the EMID issuer included the memory unique secret (MUS) at the time of manufacturing the memory device 630 in the secure memory module 140. In one embodiment, the mobile application 130 on the electronic device 120 is developed and deployed by device manufacturers, such as Samsung®. In other embodiments, all the stakeholders (involved in the payment processing) may jointly develop requirements and standard protocols.

In one embodiment, device manufacturers may develop mobile wallet technologies based on the specifics of their devices (e.g., using a mobile trusted module (MTM)/trusted platform module (TPM), Trustzone or any other relevant technology). In one embodiment, financial institutions may develop their own technologies on the cloud side that may function properly in a mobile wallet ecosystem by following standards.

In one embodiment, the mobile application 130 in the electronic device 120 has a counterpart in the private computing environment 160 of financial institutions. In one embodiment, the mobile application 130 in the electronic device 120 maintains an e-wallet table or list of the credit cards owned by the user.

In one embodiment, Trusted Computing (TC) based technologies are used to authenticate and authorize the mobile application 130 in the electronic device 120. In one embodiment, TC-based technology (e.g., presence of trusted platform module (TPM)/mobile trusted module (MTM) chip in the electronic device 120) may be used for secure communication and processing.

FIG. 8 shows a flow diagram showing a process 900 for mobile payment using the electronic device 120, according to an embodiment. In one embodiment, in block 910, a financial institution (e.g., remote host 305, FIG. 3), generates a unique credential based on user access information (e.g., username and password) and media binding information (e.g., EMID information) that is cryptographically bound to media using a unique media identification. In one embodiment, in block 920, the financial institution stores the credential and media binding identification in the form of authentication code in a memory (e.g., secure memory module 140, FIG. 2) used by an electronic device 120.

In one embodiment, a mobile wallet application (e.g., mobile application 130, FIG. 1) is launched at a merchant POS machine/system, where a user selects a particular credit card of available credit cards (e.g., e-wallet table or list) to use for a purchase/payment. In one embodiment, the user launches the mobile wallet application manually by, for example, tapping on a touch screen (e.g., display 121). In one embodiment, in block 930 the stored credential and media binding information is accessed using the user access information for a payment transaction. In one embodiment, in block 940, a digital certificate (e.g., credit card certificate) is generated using the credential and the media binding information. In one embodiment, in block 950 the digital certificate is presented to the financial institution for the payment transaction (e.g., from an NFC POS device). In one embodiment, in block 960 the memory is authenticated and the binding of the credential is verified by the financial institution (e.g., the remote host 305) prior to completing the payment transaction.

In one embodiment, the mobile device may use one or a combination of the following: (1) TrustZone to provide secure storage and domain to run the mobile wallet application (e.g., mobile application 130) and store the digital credit card information; (2) TC primitives to ensure the integrity of the software (s/w) stack that runs the mobile wallet application and to provide secured (e.g., sealed or separated) storage for digital credit cards; or (3) a similar technology to provide isolated and integrity-protected execution environment for the mobile wallet application execution and secure storage for digital credit cards.

FIG. 9 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals to/from a plurality of sinks/sources, such as, the Internet 550, a mobile electronic device 551, a server 552, or a network 553, and may be implemented using wire or cable, fiber optics, a phone line, a cellular phone link, an radio frequency (RF) link, and/or other communication channels.

In one implementation, in a mobile wireless device such as a mobile phone, the system 500 further includes an image capture device such as a camera 520. The system 500 may further include application modules as MMS module 521, SMS module 522, email module 523, social network interface (SNI) module 524, audio/video (AV) player 525, web browser 526, image capture module 527, etc.

The system 500 further includes a mobile payment processing module 530 as described herein, according to an embodiment. In one implementation of mobile payment processing module 530 along with an operating system 529 may be implemented as executable code residing in a memory of the system 500. In another embodiment, such modules are in firmware, etc.

One or more embodiments leverage EMID technology to bind a financial credential to the identity of the user at the corresponding financial organization and the device that is being used to access the financial service. In one or more embodiments, the credential management in the device occurs from the cloud computing environment using EMID technology without the direct involvement of the user.

One or more embodiments provide for simplified security mechanisms that allow the revocation of credentials by a remote host when a device is lost using EMID to bind financial credential to a certain device and user. In one or more embodiments, the use of cloud based technology allows the temporary storage of secure element (credential) in the device memory/removable memory or the cloud host. In one or more embodiments, the financial institution may update the credential and reinstall the credential if the device is lost or stolen. In one or more embodiments, the cloud host acts as an escrow that may update the credential immediately in case the device is lost or stolen. One or more embodiments provide for the periodic update of the credential by associating an expiry time associated with it to further improve the security.

In one or more embodiments, the use of cloud based approach is used to move secure storage elements (credentials) between the device and the cloud. In one or more embodiments, the credential stored in a stolen device cannot be decrypted correctly without the knowledge of username and password of the rightful owner of the credential.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for mobile payment, comprising:
generating, by a financial institution, a unique credential based on user access information and media binding information that is cryptographically bound to media using a unique media identification;
storing, by the financial institution, the credential and media binding information in the form of authentication code in a memory used by an electronic device;
accessing the stored credential and media binding information using the user access information for a payment transaction;
generating a digital certificate using the credential and the media binding information;
presenting the digital certificate to the financial institution for the payment transaction; and
authenticating the memory and verifying binding of the credential to the memory prior to completing the payment transaction.

2. The method of claim 1, wherein the credential is stored in an assigned protected area of the memory by the financial institution.

3. The method of claim 2, further comprising:
selecting a payment method for the payment transaction by using an application to select a credit card from a stored list of one or more credit cards.

4. The method of claim 2, wherein a separate credential is associated with a financial institution for each credit card available for selection, and each separate credential is stored in a unique assigned protected area of the memory.

5. The method of claim 1, further comprising storing expiration information in the memory for limiting access time of the credential and for updating the credential periodically by the financial institution.

6. The method of claim 2, wherein the financial institution comprises a local or remote host.

7. The method of claim 6, wherein presenting the digital certificate to the financial institution for the payment transaction comprises sending the digital certificate for payment processing from the electronic device to a payment method reader, wherein the payment method reader comprises a near field communication (NFC) reader, and the digital certificate is passed over an NFC interface of the electronic device to the NFC reader.

8. The method of claim 1, wherein the user access information comprises a username and password.

9. The method of claim 8, wherein the media information comprises an enhanced media identification (EMID) generated based on a unique code embedded in the memory at a time of manufacturing the memory, and the credential is reinstalled by the financial institution when the electronic device is lost or stolen.

10. The method of claim 8, wherein the financial institution generates an authorization key based on the username, password and enhanced media identification (EMID), and stores the authentication key on the memory.

11. The method of claim 9, wherein the electronic device uses the authentication key to decrypt the credential.

12. The method of claim 1, wherein the memory is one of a memory device embedded in the electronic device or a removable memory device.

13. The method of claim 1, wherein the electronic device comprises a mobile device.

14. A system for mobile payment, comprising:
a server that generates a unique credential based on user access information and media binding information that is cryptographically bound to media using a unique media identification, and stores the credential and media binding information in the form of authentication code in a memory used by an electronic device through a secure channel;
an electronic device that accesses the stored credential and media binding information from the memory using the user access information for a payment transaction, and generates a digital certificate using the credential and the media binding information; and
a near field communication (NFC) interface that passes the digital certificate to the server for the payment transaction,
wherein the server authenticates the memory and verifies binding of the credential to the memory prior to completing the payment transaction.

15. The system of claim 14, wherein a payment method is selected by the electronic device, wherein the payment method comprises selecting a digital credit card, and the NFC interface passes the digital certificate to an NFC reader for a point-of-service (POS) system for requesting payment using a selected credit card from a list of stored digital credit cards stored in the memory.

16. The system of claim 14, wherein the server comprises a local or remote financial entity server.

17. The system of claim 16, wherein the financial entity server stores the credential in an assigned protected area of the memory.

18. The system of claim 14, wherein the financial entity server stores expiration information in the memory for limiting access time of the credential and for updating the credential periodically.

19. The system of claim 14, wherein the user access information comprises a username and password.

20. The system of claim 19, wherein the media information comprises an enhanced media identification (EMID) generated by the server based on a unique code embedded in the memory at a time of manufacturing the memory.

21. The system of claim 20, wherein the server generates an authorization key based on the username, password and EMID, and stores the authentication key on the memory.

22. The system of claim 21, wherein the electronic device uses the authentication key to decrypt the credential, and the memory is one of a memory device embedded in the electronic device or a removable memory device.

23. The system of claim 14, wherein the electronic device comprises a mobile device.

24. A server for mobile payment, comprising:
a credential service that uses a processor to generate a unique credential based on user access information and media binding information that is cryptographically bound to media using a unique media identification, and stores the credential and media binding information in the form of authentication code in a memory used by an electronic device through a secure channel; and
an authorization service that authenticates the memory and verifies binding of the credential to the memory prior to completing a requested payment transaction based on a digital certificate generated by the electronic device using the credential and media binding information.

25. The server of claim 24, wherein the server comprises a remote or local financial entity server.

26. The server of claim 25, wherein the credential service stores the credential in an assigned protected area of the memory, and the memory is one of a memory device embedded in the electronic device or a removable memory device.

27. The server of claim 24, wherein the credential service stores expiration information in the memory for limiting access time of the credential and for updating the credential periodically.

28. The server of claim 24, wherein the user access information comprises a username and password.

29. The server of claim 28, wherein the media information comprises an enhanced media identification (EMID) generated by the credential service based on a unique code embedded in the memory at a time of manufacturing the memory, wherein the credential service generates an authorization key based on the username, password and EMID, and stores the authentication key on the memory, and the electronic device uses the authentication key to decrypt the credential.

30. The server of claim 24, wherein the electronic device comprises a mobile device.
